(19) United States
(12) Patent Application Publication
(10) Pub. No.: US 2004/0073499 A1
(43) Pub. Date: Apr. 15, 2004

(54) Method and system for delivery of distressed shipments

(76) Inventors: Lisa S. Martin, Austin, TX (US); Monica Lynn Carson, Round Rock, TX (US); Tracy Ann Masson, Austin, TX (US); Cynthia Denise Trapper, Pflugerville, TX (US); James L. Roberts, Round Rock, TX (US)

Correspondence Address: HAMILTON & TERRILE, LLP, P.O. BOX 203518, AUSTIN, TX, 78720, US

(21) Appl. No.: 10/272,059

(22) Filed: Oct. 15, 2002

(51) Int. Cl. G06F 17/60

(52) U.S. Cl. 705/28

(57) ABSTRACT

Shipment delivery by a shipper to a receiver is monitored by a sender to identify return events as distressed shipments for sender intervention. For instance, a monitoring engine detects incorrect address, receiver unavailable and receiver refusal return events from shipper tracking status information. A prioritization engine associates the shipper information with sender order information to prioritize the nature of sender intervention. An update engine provides user interfaces to guide sender representatives through resolution of distressed shipments to update delivery of the shipment. A transmission engine communicates the update delivery instructions from the sender to the shipper, such as by sending a XML formatted EDI message.

### BACKGROUND OF THE INVENTION

1. Field of the Invention

The present invention relates to the field of shipment delivery, and more particularly to a method and system for delivery of distressed shipments of information handling systems.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The wide variation in information handling system configurations provides consumers with a great number of choices in the purchase of an information handling system but presents manufacturers with a complex problem of accepting and filling consumer orders for different information handling system configurations. One technique used by manufacturers is to accept a consumer order for a desired configuration, to build the information handling system according to the consumer order and then to ship the built-to-order system to the consumer. One difficulty with building information handling systems to order is managing the logistics of getting a system ordered by a consumer to that consumer. If a mistake is made in the manufacture or price of an order, the consumer will often refuse delivery of the shipment resulting in a return of the shipment to the manufacturer. Further, in the time between the placement of an order, the manufacture of the ordered information handling system and the shipping of the information handling system to the consumer, the consumer may become unavailable at the delivery address resulting in a return of the information handling system to the manufacturer. Returns are costly in reduced satisfaction to consumers and increased shipping costs to get the consumer's order filled. Returns are also costly because the returned system is typically not marketable as a new system and is instead is often sold as refurbished at a reduced price.

Shippers typically attempt to resolve some return events so that shipments are delivered successfully rather than returned. For instance, shipper delivery personnel typically carry wireless PDA devices to communicate delivery status information for shipments to the shipper. In the event of a return event, such as an improper address or unavailable receiver, the shipper will often leave written messages that a reattempt will occur and will sometimes attempt to contact the receiver by phone to arrange a delivery of the shipment. However, shippers have limited information on the content of the shipment and the nature of the receiver and are thus somewhat limited in the actions that they can take. Typically, shippers will inform senders of a return event such as by sending an Electronic Data Interchange (“EDI”) message. This data is typically stored in a database, however, is generally not stored in a format that is readily available to support sender intervention to resolve the return event before the shipment is returned to the sender.

### SUMMARY OF THE INVENTION

Therefore, a need has arisen for a method and system which promotes sender intervention in shipment delivery for resolution of shipment return events before the shipment is returned to the sender.

A further need exists for a method and system which provides sender monitoring of shipper return events to identify predetermined shipments as distressed for sender intervention.

A further need exists for a method and system which routes and prioritizes distressed shipments for resolution by a sender representative and provide real-time updates of shipment information to the shipper based on the resolution.

In accordance with the present invention, a method and system are provided which substantially eliminate or reduce the disadvantages and problems associated with previous methods and systems for managing shipment return events. Shipper return event messages are monitored by a sender to identify predetermined return events as distressed shipments. The sender intervenes to resolve the distressed shipments based on the return event notification received from the shipper and updates shipment information for the shipper to deliver the shipment before the shipment is returned to the sender.

More specifically, a monitoring engine monitors electronic messages from a shipper shipment status tracker to detect return events, such as unsuccessful delivery attempts that fail due to an incorrect address, an unavailable receiver or a receiver refusal. A prioritization engine applies predetermined criterion to identify return events as distressed shipments for sender intervention. The prioritization engine uses internal sender order information associated with the distressed shipment to route handling of the resolution of the distressed shipment by a desired sender representative. An update engine guides the representative through resolution of the distressed shipment by checking the consistency of the shipper and sender information for review and to contact the receiver. For instance, with an incorrect address return event, the original shipping address from the sender is displayed and compared with the address from the sender order to detect any grammatical errors. Once a resolution is reached, a transmission engine provides updated delivery instructions to the shipper based on the resolution to achieve a successful delivery.

The present invention provides a number of important technical advantages. One example of an important technical advantage is that a sender is able to selectively intervene to resolve shipment return events based on data of the shipper for products that are outside of the control of the physical sender, thus decreasing the amount of shipment returns that occur. Sender intervention that results in altered shipment instructions to achieve a successful delivery are communicated to the shipper on a real time basis so that delivery re-attempts are performed based on the updated instructions. Further, the sender may then track the effect of the updated shipment instructions through a successful delivery by monitoring return events associated with the shipment until a proof of delivery is provided.

Another example of an important technical advantage is that a sender is able to monitor shipper return events to identify predetermined return events as distressed shipments for management by the sender, thus better applying sender and shipper resources in a timely manner. For instance, return events related to receiver refusal of a shipment typically are not amenable to resolution by the shipper. In contrast, a sender has more resources and customer data to resolve misunderstandings that result in a refused shipment such as by contacting the receiver to discuss shipment pricing and components. The timely identification of refused shipments for intervention by the sender results in successful delivery reattempts before return of the shipment to the sender, thus reducing shipment costs and increasing receiver satisfaction.

Another example of an important technical advantage is that a sender is able to prioritize distressed shipments for improved overall shipment delivery results. For instance, a sender may focus resources to ensure delivery of higher-value distressed shipments or may focus resources based on the identity of the receiver, on the type of distressed shipment or on other internal information not available to the shipper. By selecting distressed shipments for resolution with internal information unavailable to the shipper, the sender is better able to apply internal resources on those shipments for which sender intervention has a greater likelihood of success while allowing the shipper to manage return events for which sender resources will not result in improved delivery success.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a system for managing distressed shipments;

FIG. 2 depicts a functional block diagram of a distressed shipment management system;

FIG. 3 depicts a process for determining return events to identify as distressed shipments;

FIG. 4 depicts a process for managing receiver incorrect address distressed shipments;

FIG. 5 depicts a process for managing receiver unavailable distressed shipments;

FIG. 6 depicts a process for managing receiver refusal distressed shipments;

FIG. 7 depicts one embodiment of a user interface for updating distressed shipment information; and

FIG. 8 depicts another embodiment of a user interface for updating distressed shipment information.

### DETAILED DESCRIPTION

The delivery of built-to-order information handling systems presents a complex logistical problem that will inevitably have some mistakes between the ordering and the delivery of the system, whether the mistakes originate with the customer, the manufacturing process or the delivery of the system. The present invention manages information handling system delivery to resolve difficulties in an efficient manner with cooperation between the sender and the shipper of the information handling system. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

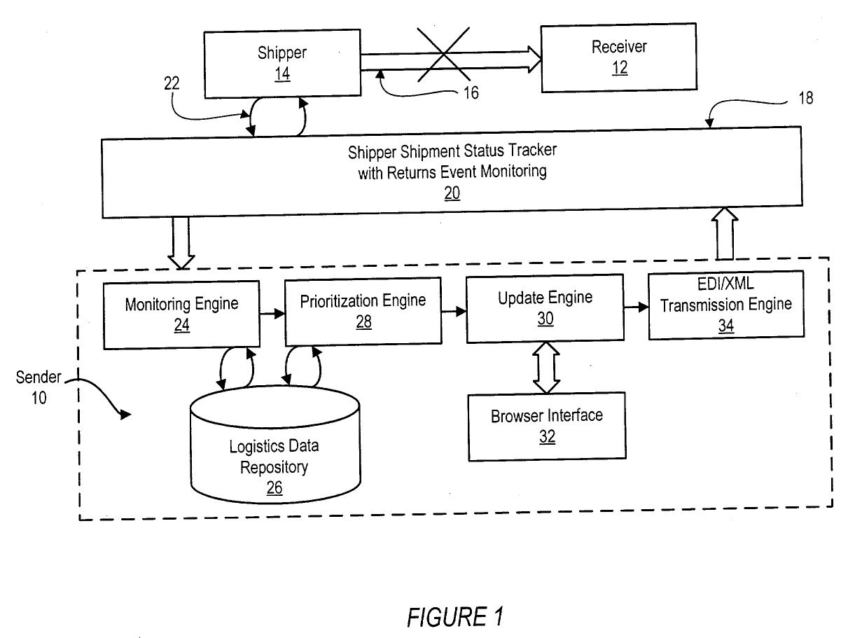

Referring now to FIG. 1, a block diagram depicts a system for managing distressed shipments from a sender 10 to a receiver 12 through a shipper 14. As depicted by arrow 16, a shipment return event occurs if shipper 14 is unable to deliver a shipment to receiver 12. Shipper 14 communicates the return event to a shipment status tracker 20, such as by using a wireless communication 22 from a PDA device to a shipper network. Shipment status tracker 20 typically includes return event monitoring codes that identify the type of return event, such as an incorrect address, a receiver unavailable or a receiver refusal. Shipper 14 uses the return event codes to attempt to resolve the return event, such as by checking on and correcting incorrect addresses. Shipment status tracker 20 communicates return events to sender 10, such as with an EDI message that includes the return event monitoring codes, so that sender 10 may also attempt to resolve return events.

At sender 10, a logistics data repository 26 receives EDI messages from shipment status tracker 20. A monitoring engine 24 monitors the return event monitoring codes to identify distressed shipments. Monitoring engine 24 identifies predetermined return events as distressed shipments to a prioritization engine 28. For instance, in one embodiment monitoring engine 24 forwards incorrect address return events as distressed shipments if the return events codes indicate that the shipper has failed to determine the correct address and withholds incorrect address return events from prioritization engine 28 if shipper 14 continues to attempt to resolve the incorrect address. Prioritization engine 28 orders the return events identified as distressed shipments for resolution by sender 10 from a highest to lowest priority. For instance, distressed shipments are ordered to optimize savings for sender 10 by weighing the likelihood of resolution, the cost to the sender of a return and the resources available for resolution for each distressed shipment identified by monitoring engine 24. Update engine 30 presents the prioritized distressed shipments to sender representatives through a browser-based user interface 32 that guides the representative through steps for resolution of the distressed shipment. If a resolution is achieved by update engine 30, then updated shipment information is provided to an EDI/XML transmission engine 34 which formats a message that updates shipper 14's delivery instructions through shipment status tracker 20.

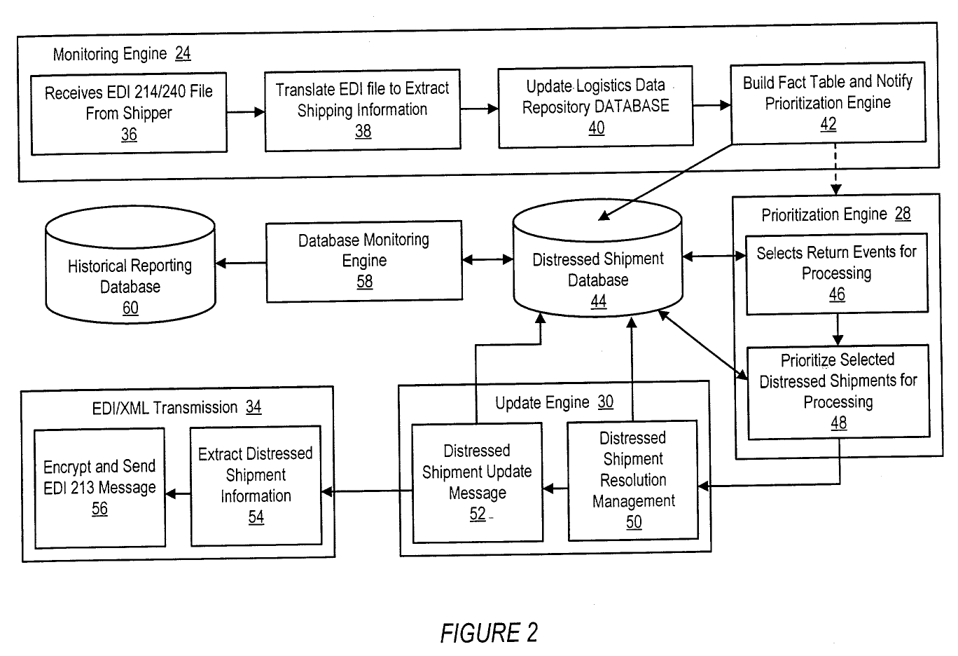

Referring now to FIG. 2, a functional block diagram depicts steps performed to manage the delivery of a distressed shipment. At step 36, monitoring engine 24 receives EDI 214/240 files from shipper 14. At step 38, the EDI file is translated to extract shipping information including the return event monitoring codes. At step 40, monitoring engine 24 updates the logistics data repository database 26 to allow sender 14 to track shipments, including successful shipment deliveries. At step 42, monitoring engine 24 builds a fact table of distressed shipments, updates a distressed shipment database 44 and notifies prioritization engine 28 of the identified distressed shipments. The fact table built at step 42 identifies selected shipments having return event codes as distressed shipments based on predetermined criterion. As one example, only shipments with receiver refused return values are identified as distressed shipments in order to focus sender resources on increasing successful shipments by reducing returns that the shipper is unable to resolve.

At step 46, prioritization engine 28 selects return events for processing as distressed shipments by interacting with distressed shipment database 44. At step 48, prioritization engine 28 prioritizes selected distressed shipments for resolution. For instance, distressed shipments may be prioritized based upon the type of return event, the cost of the distressed shipment, the value of the resolution, and the adequacy of time available to achieve resolution. The prioritized distressed shipments are provided to update engine 30 and, at step 50, distressed shipment resolution is managed with a set of graphical user interfaces that guide representatives through a resolution process. At step 52, a distressed shipment update message is prepared in accordance with the resolution achieved by the representative and provide to EDI/XML transmission engine 34. At step 54, distressed shipment information is extracted to provide real-time alterations to shipper delivery instructions, and at step 56, the extracted distressed shipment information is encrypted and sent as an EDI 213 message to the shipper. Thus, shipment status tracker 20 is able to forward instructions directly to shipper 14 infrastructure to relay requested delivery actions on a real time basis. As distressed shipments are resolve, either as deliveries to receivers 12 or returns to sender 10, a database monitoring engine 58 maintains the currency of distressed shipment database 44 and stores results in historical reporting database 60.

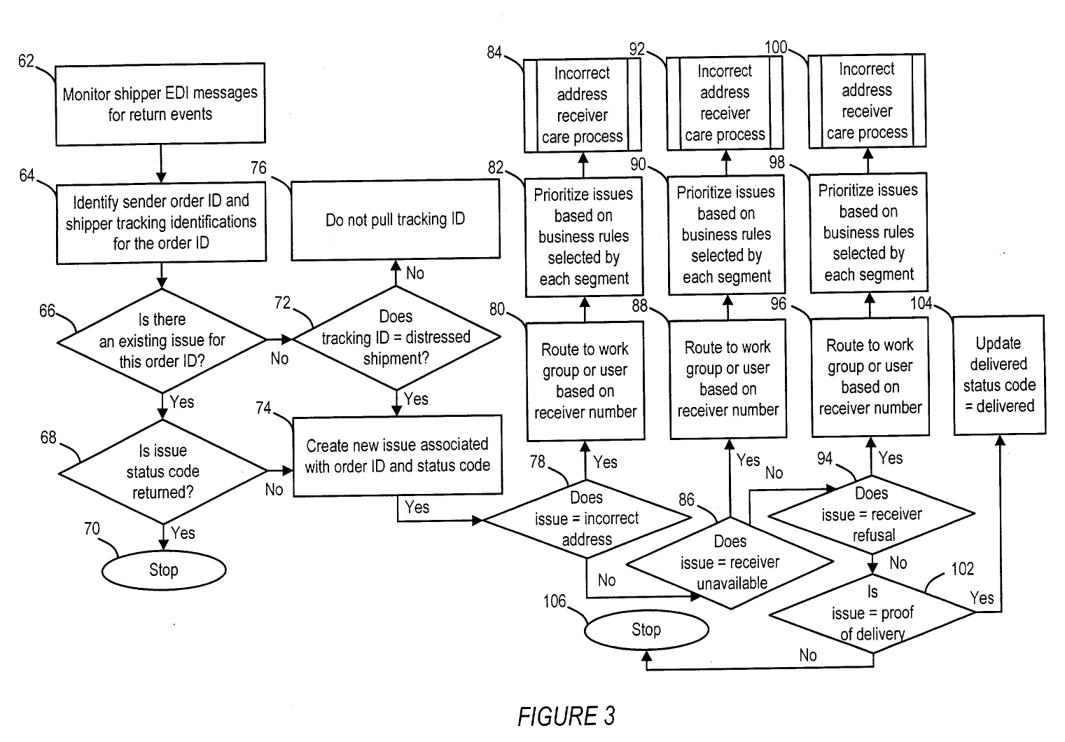

Referring now to FIG. 3, a flow diagram depicts the process for monitoring shipper status information to identify and categorize return events as distressed shipments. At step 62, shipper EDI messages are monitored to detect return events and at step 64, detected return events are associated with a sender order identification by the shipper tracking identification. At step 66, a determination is made of whether a return event issue already exists for the order identification. If yes, then at step 68 the shipper status code is checked to determine if the shipment is already returned, in which case the process stops at step 70. If at step 68 the shipment is not already returned, a new issue is created and the process proceeds to step 74 for resolution of the existing and new issue as a distressed shipment. If, at step 66, no other return event issue exists, then the process proceeds to step 72 for a determination of whether the return event identified by the tracking identification represents a distressed shipment. If the return event does not represent a distressed shipment for which resolution is desired, the process proceeds to step 76 and the tracking identification is not pulled for resolution by the sender. For instance, in one embodiment, if the return event indicates that a first attempt at delivery is unsuccessful due to an incorrect address or receiver unavailable, the process proceeds to step 76 to allow the shipper to attempt resolution. If the return event indicates that a second attempt at delivery is unsuccessful for the same reason, then the process proceeds to step 74 to allow the sender to attempt resolution as a distressed shipment. In contrast, if the event indicates a receiver refusal on any delivery attempt, the process proceeds to step 74 for sender intervention.

At step 74, the tracking identification and associated order identification are assigned a status code for tracking the resolution of the issue. At step 78, if the issue code indicates an incorrect address distressed shipment, then at step 80 resolution for the order is routed to a work group or user based on the receiver, at step 82 the resolution is prioritized based on business rules for the receiver, and at step 84 the process advances to an incorrect address care process. If at step 78 the issue code does not indicate an incorrect address, then the process proceeds to step 86 to determine if the issue indicates a receiver unavailable distressed shipment. If yes, the process proceeds to step 88 for routing to a work group or user based on the receiver, to step 90 for prioritization based on business rules for the receiver, and to step 92 for an undeliverable receiver care process. If no at step 86, the process proceeds to step 94 for a determination of whether the issue indicates a receiver refusal. If yes, then at step 96 the order is routed to a work group or user based on the receiver, at step 98 the resolution is prioritized based on business rules for the receiver and to step 100 for a refusal receiver care process. If the determination at step 94 is no, the process proceeds to step 102 to determine if the issue indicates a proof of delivery for the shipment. If yes, then at step 104 the status code is updated for the distressed shipment database to indicated delivery. If no, the process stops at step 106.

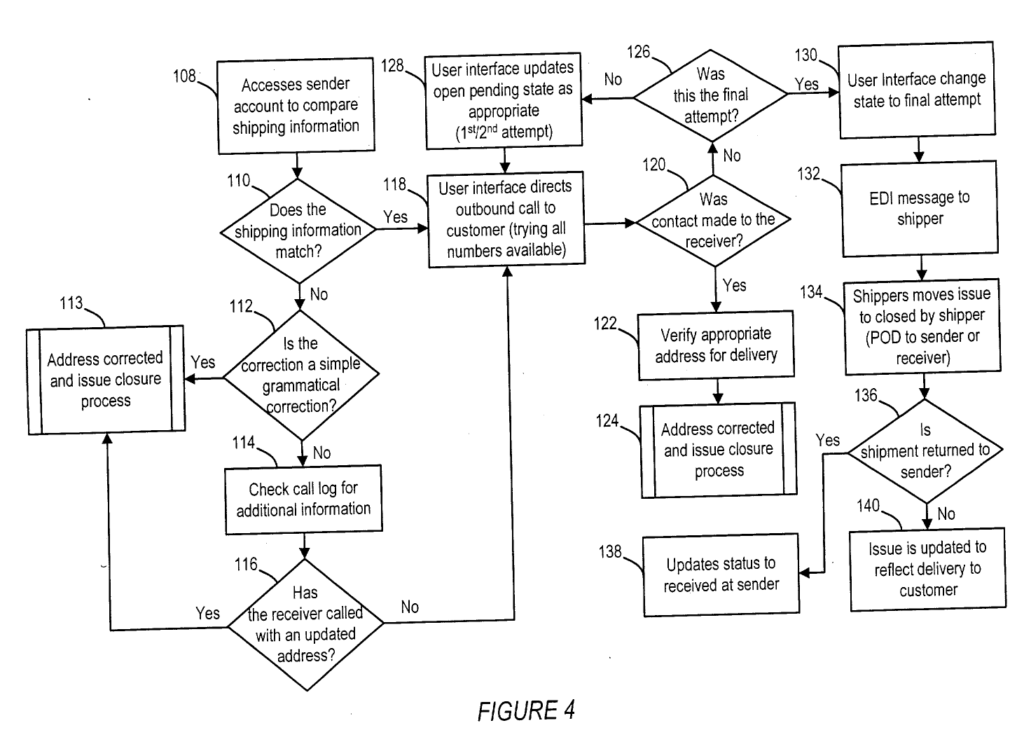

Referring now to FIG. 4, a flow diagram depicts the incorrect address care process selected at step 84 of FIG. 3. At step 108, the sender account is accessed based on the sender order number to compare the shipper's shipping information with the sender's shipping information at step 110. If the information does not match, then at step 112 the information is checked for simple grammatical errors which, if detected, are corrected at step 113 for closure of the incorrect address issue. If the error is not readily corrected, the process proceeds to step 114 to check the call log for additional information and, at step 116, if corrected address information was provided by the receiver, the address information is corrected and the issue closed at step 113.

If the sender and shipper address information match at step 110 or no additional address information was provided at step 116, the process proceeds to step 118 at which a user interface directs an outbound call with all available numbers by a sender representative to the receiver. If the representative indicates a contact was made with the receiver at step 120, the address is updated at step 122 and at step 124 the address is corrected for the shipper and the issue closed. If the representative failed to contact the receiver at step 120, then at step 126 a determination is made of whether the number of attempts to contact the receiver equals a final number of attempts. If not, at step 128 a counter of the user interface advances and a new attempt to contact the receiver is scheduled. If the attempt at step 126 is final, at step 130 the user interface changes the attempt to final and at step 132, an EDI message is sent to the shipper to indicate that the sender would not attempt to resolve the incorrect address any further. At step 134, the shipper moves the issue to closed and the shipment is delivered. At step 136, a determination is made of whether the shipment was returned to sender. If yes, the sender order status is updated at step 138 to returned to sender and if no the process ends at step 140 and the issue is updated to reflect delivery to the customer.

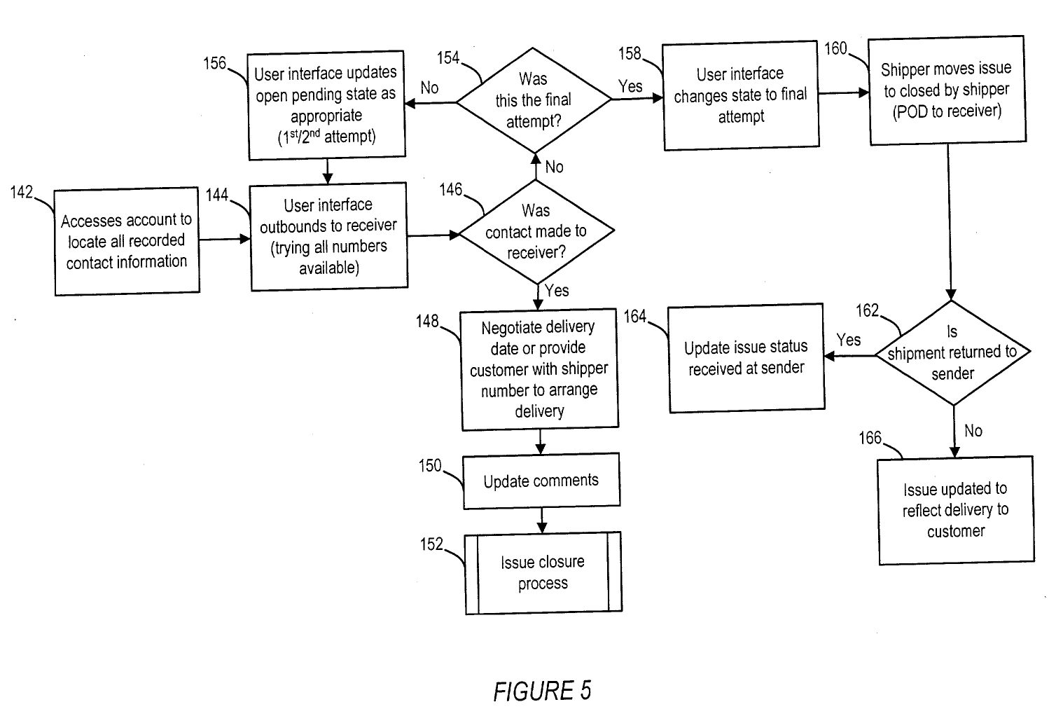

Referring now to FIG. 5, a flow diagram depicts the undeliverable care process from step 92 of FIG. 3. At step 142, the sender account is accessed to locate contact information for the receiver. At step 144, the user interface guides a representative attempt to contact the receiver. At step 146, if the receiver is contacted the process proceeds to step 148 for the user interface to guide the sender representative to negotiate a delivery or to contact the shipper, to step 150 to accept representative comments and to step 152 to close the issue. If at step 146 contact is not made with the receiver, then at step 154 a determination is made of whether the attempt is a final attempt. If the attempt is not final, a counter is advanced at step 156 and another attempt is scheduled. If the attempt is final, the user interface indicates a final attempt at step 158 and at step 160 the shipper moves the issue to closed by the shipper. At step 162, a determination is made of whether the shipment is returned to the sender and, if so, at step 164 the order is updated to indicate an issue status of returned to sender.

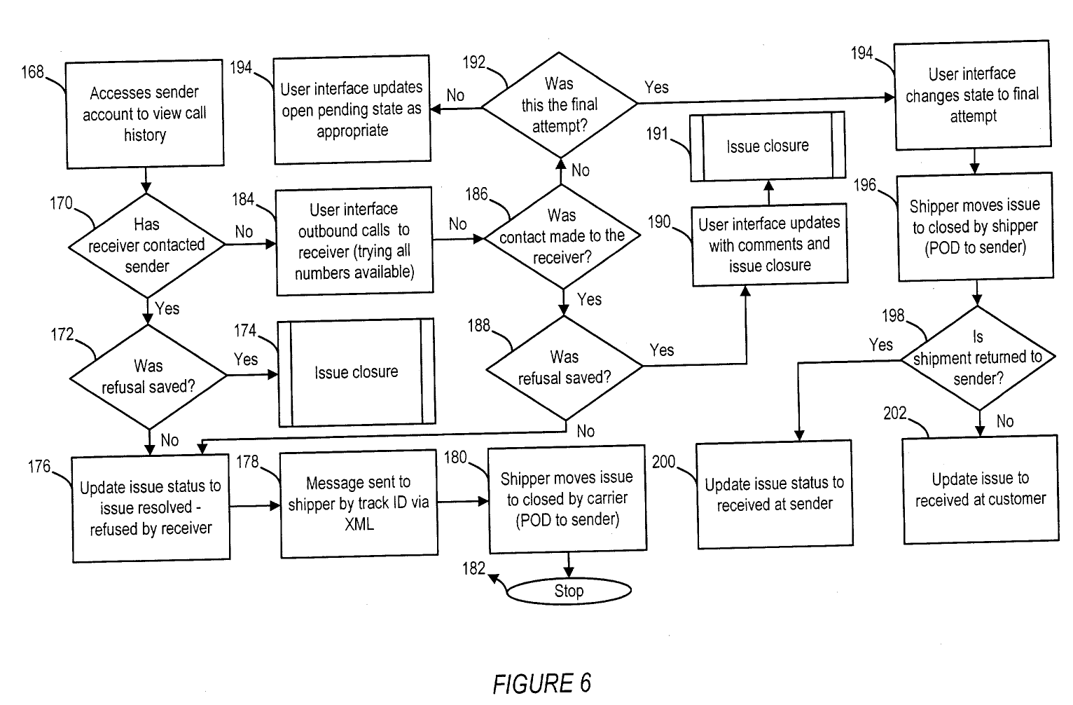

Referring now to FIG. 6, a flow diagram depicts the refusal receiver care process from step 100 of FIG. 3. At step 168, the sender call history for the receiver and order number are accessed to determine at step 170 whether the receiver has contacted the sender regarding the refusal. If yes, at step 172 a determination is made of whether the refusal was saved, in which case at step 174 the issue is closed. If at step 172 the refusal was not saved, then the issue status is updated at step 176 to indicate refusal by the receiver, at step 178 a message is sent to the sender by tracking identification with XML based instructions that the refusal is confirmed, at step 180 the shipper changes the status to closed by sender and the process stops at step 182.

If at step 170 the receiver has not contacted the sender regarding the refusal, at step 184 the user interface guides a sender representative through an attempt to contact the receiver to resolve the refusal. At step 186, if a contact is made with the receiver, then at step 188 the user interface accepts input for the outcome of the contact and, at step 190 if the refusal is saved the issue is updated and closed at step 191. If at step 186 a contact is not made with the receiver, then at step 192 a determination is made of whether the contact attempt was a final attempt. If not, at step 194 the user interface advances a counter and another attempt is scheduled. If a final attempt at step 192, then at step 196 the shipper moves the issue to closed by the shipper and the shipment is returned to the sender. At step 198 a determination is made of whether the shipment is received at the sender and, if yes, at step 200 the issue status is updated to received at sender.

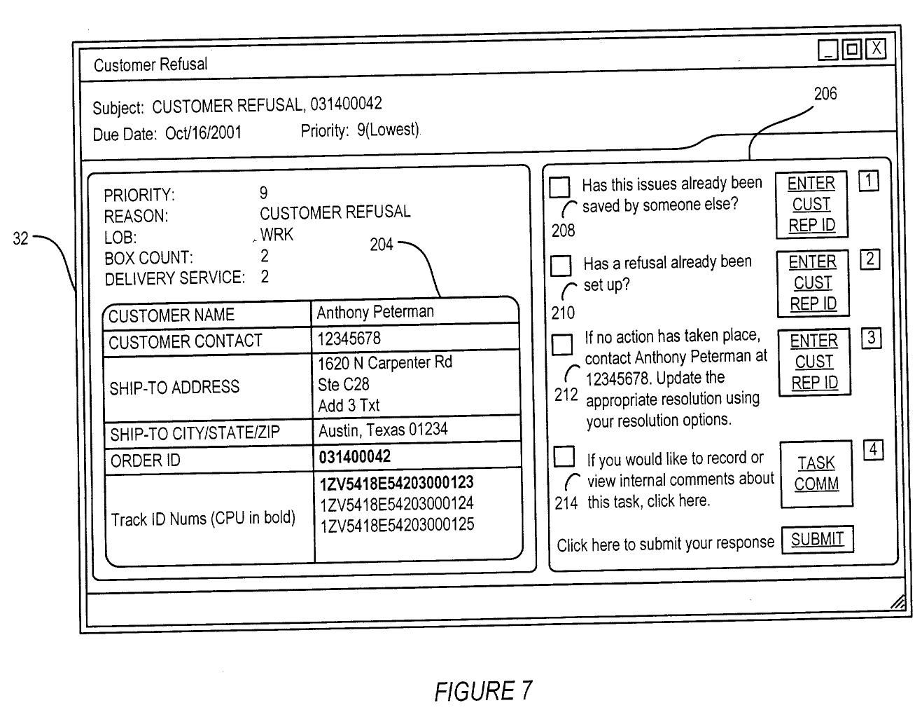

Referring now to FIG. 7, one example of a graphical user interface 32 presented as a Web page accessed through a browser is depicted. User interface 32 depicts information presented to a sender representative to guide the representative through interaction with a receiver who has refused a shipment. Contact and order information for the receiver 204 is provided with links that allow the representative to review more detailed information. A resolution window 206 depicts four resolution steps 208-214 with each step having a link that the representative may activate for additional information. Resolution step 208 directs the representative to check if the refusal was already saved. Resolution step 210 directs the representative to check if the refusal already exists as an issue. Resolution 212 directs the representative to initiate a contact and pursue available resolution options. Resolution step 214 allows the representative to review and submit internal comments relating to the refusal issue.

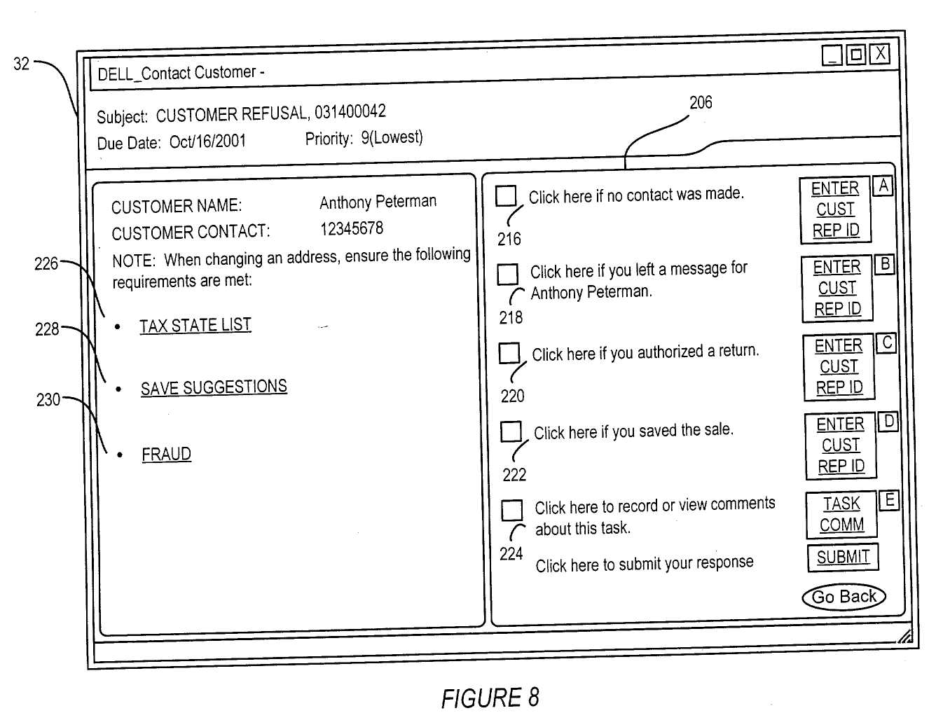

Referring now to FIG. 8, a graphical user interface 32 depicts a resolution window 206 with resolution steps 216-224 that are presented to the representative if resolution step 212 is selected from FIG. 7. Resolution step 216 is activated if no contact is made and resolution step 218 is activated if a message is left for the receiver. Resolution step 220 is activated if a return is authorized, such as if the refusal is not saved. Resolution step 222 is selected if the refusal is saved to initiate the process of sending a message to the shipper to reattempt delivery. To aid in accomplishing a save, aids for the representative are presented through user interface, such as a tax state list link 226 and a livewire link 228. Tax state list link 226 provides information on the computations for state taxes, a common area of misunderstanding for receivers who have purchased an item. A save suggestions link 228 provides suggestions to aid in reaching a save of the refusal, such as additional offerings or price reductions. A fraud link 230 provides information to the representative for the reporting of events that indicate fraud. Resolution step 224 is available for the representative to view or record comments on the issue.

Although the present invention has been described in detail, it should be understood that various changes, substitutions and alterations can be made hereto without departing from the spirit and scope of the invention as defined by the appended claims.

What is claimed is:

1. A method for updating delivery instructions to a shipper for use in delivering a shipment from a sender to a receiver, the method comprising:
monitoring shipper shipment tracking status updates received electronically by the sender to detect a return event associated with a shipment;
identifying by the sender of the return event as a distressed shipment;
processing the distressed shipment by the sender to generate updated shipment instructions; and
communicating electronically the updated shipment instructions to the shipper for use in re-attempting delivery of the distressed shipment.

2. The method of claim 1 wherein the distressed shipment comprises a refusal by the receiver to accept the shipment.

3. The method of claim 2 wherein processing the distressed shipment comprises instructing the shipper to reattempt delivery of the shipment to a new address.

4. The method of claim 3 wherein processing the distressed shipment further comprises reducing the price of the shipment.

5. The method of claim 1 wherein the distressed shipment comprises an incorrect receiver address.

6. The method of claim 1 wherein the distressed shipment comprises an unavailable receiver.

7. The method of claim 1 further comprising:
detecting by the sender of plural distressed shipments; and
prioritizing the resolving of the distressed shipments by the sender.

8. The method of claim 7 wherein prioritizing the resolving of the distressed shipments further comprises resolving refused shipments with a higher priority than other distressed shipments.

9. The method of claim 1 wherein communicating electronically further comprises sending an Electronic Data Interchange message from the sender to the shipper.

10. The method of claim 1 wherein the distressed shipment comprises an information handling system.

11. A system for updating shipping instructions to a shipper for use in delivery of a distressed shipment by a sender to a receiver, the system comprising:
a monitoring engine operable to communicate with a shipper status tracker to detect distressed shipments;
an update engine associated with the sender and interfaced with the monitoring engine, the update engine operable to update delivery instructions for use in re-attempting delivery of the distressed shipment to reattempt delivery in a defined manner; and
a transmission engine interfaced with the update engine and the shipper status tracker, the transmission engine operable to communicate the updated delivery instructions to the shipper.

12. The system of claim 11 further comprising a prioritization engine interfaced with the monitoring engine and operable to prioritize the distressed shipment for handling by the update engine.

13. The system of claim 11 wherein the distressed shipment comprises a receiver refusal.

14. The system of claim 11 wherein the distressed shipment comprises an incorrect receiver address.

15. The system of claim 11 wherein the distressed shipment comprises an unavailable receiver.

16. A method for delivery of a distressed shipment to a receiver, the method comprising:
communicating shipper information associated with the distressed shipment to the sender of the shipment;
resolving the distressed shipment by the sender;
updating the shipper information by the sender to incorporate the resolution of the distressed shipment; and
sending the updated shipper information from the sender to the shipper.

17. The method of claim 16 wherein resolving the distressed shipment further comprises comparing the receiver address from the shipper information with the receiver address from sender information.

18. The method of claim 17 wherein the address from the sender information comprises an address provided by the receiver, the receiver address from the shipper information differing from the sender information due to a grammatical error.

19. The method claim 17 wherein the address from the sender information comprises an address updated by the receiver to the sender after the shipment was sent from the sender to the shipper.

20. The method of claim 16 wherein resolving the distressed shipment further comprises:
determining sender order information associated with the shipper information; and
forwarding the distressed shipment information to a representative associated with the order information.

21. The method of claim 16 further comprising prioritizing the distressed shipment for resolving based on the cost of the distressed shipment.

22. The method of claim 16 further comprising prioritizing the distressed shipment based on the type of return event.

23. The method of claim 16 wherein the distressed shipment comprises a receiver refusal and wherein resolving further comprises:
initiating communication by the sender to the receiver; and
re-negotiating the price of the shipment.

24. The method of claim 23 wherein the shipment comprises an information handling system and the receiver refusal is associated with an incorrect configuration.

25. The method of claim 23 wherein the receiver refusal is associated with an incorrect price of the shipment.

26. The method of claim 25 wherein the incorrect price comprises an incorrect tax computation.

27. The method of claim 16 wherein sending further comprises sending an XML formatted message to the shipper.
